(19) United States
(12) Patent Application Publication
(10) Pub. No.: US 2013/0231979 A1
(43) Pub. Date: Sep. 5, 2013

(54) SERVICE EFFICIENCY METRIC

(71) Applicants: Dean Nelson, Saratoga, CA (US); Jeremy Rodriguez, Sunnyvale, CA (US)

(72) Inventors: Dean Nelson, Saratoga, CA (US); Jeremy Rodriguez, Sunnyvale, CA (US)

(73) Assignee: eBay Inc., San Jose, CA (US)

(21) Appl. No.: 13/544,510

(22) Filed: Jul. 9, 2012

Related U.S. Application Data
(60) Provisional application No. 61/606,842, filed on Mar. 5, 2012.

(51) Int. Cl. G06Q 10/00

(52) U.S. Cl. 705/7.38

(57) ABSTRACT

A method and a system for generating one or more service efficiency metrics are provided in this disclosure. According to various exemplary embodiments, a system receives transaction information and power consumption information of an online business. Moreover, the system generates, using one or more processors, a service efficiency metric based on the transaction information and the power consumption information, the service efficiency metric indicating a number of transactions executed via the online business during a specific time period per unit of power consumed in executing the transactions during the specific time period.

### CROSS-REFERENCE TO RELATED APPLICATIONS

This application claims the priority benefit of U.S. Provisional Application No. 61/606,842, filed Mar. 5, 2012, which is incorporated herein by reference.

### TECHNICAL FIELD

The present application relates generally to the technical field of tracking the efficiency of systems and, in one specific example, to a service efficiency management system.

### BACKGROUND

Many businesses (such as, for example, search engine websites, e-commerce websites, marketplace websites, etc.) rely on data centers that process large amounts of data. Data centers typically include many server computers and other devices that consume power. Data center power consumption is currently on the rise and is expected to continue growing rapidly, particularly due to the popularity of mobile devices and the millions of users connecting to the Internet.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 illustrates various examples of operations information received and managed by a data management module, according to various embodiments.

FIG. 4 illustrates an exemplary data structure containing various operations information received and managed by a data management module, according to various embodiments.

FIG. 5 illustrates an example portion of a user interface screen displayed by a system, according to various exemplary embodiments.

FIG. 6 is a flowchart illustrating an example method, according to various embodiments.

FIG. 7 is a flowchart illustrating an example method, according to various embodiments.

FIG. 8 is a flowchart illustrating an example method, according to various embodiments.

FIG. 9 is a flowchart illustrating an example method, according to various embodiments.

FIG. 10 is a flowchart illustrating an example method, according to various embodiments.

FIG. 11 is a flowchart illustrating an example method, according to various embodiments.

FIG. 12 is a diagrammatic representation of machine in the example form of a computer system within which a set of instructions, for causing the machine to perform any one or more of the methodologies discussed herein, may be executed.

### DETAILED DESCRIPTION

Example methods and systems to for managing service efficiency are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a service efficiency management system generates one or more metrics that may be used to track various aspects of an entity or system. Generally, a metric may be defined as an analytical measurement intended to quantify a state or a characteristic of a system. For example, the service efficiency management system of this disclosure may generate a service efficiency metric of transactions per watt of electrical power. This metric tracks how efficiently online and offline businesses (such as marketplace websites) deliver core services to customers. In particular, the system produces the “transactions per watt” metric based on how customers consume services of the business (actual user transactions) and the total amount of power to deliver those services (watts). An example of a transaction is an instance of transmitting data in response to a user interaction received via a network, such as: providing search results in response to a received query, providing an interface used to collect data from a user in response to a request, providing a confirmation message in response to receiving the collected data, and so forth.

Thus, all changes in the infrastructure of the business (e.g., data center consolidation, technology refresh, code optimization, etc.) may either increase or decrease the number of transactions performed per watt of power consumed by the data center. The higher the number of transactions in the “transactions per watt” service efficiency metric, the more efficiently the services are being delivered. In essence, the “transactions per watt” efficiency metric of a company's infrastructure may be treated as analogous to the “miles per gallon” efficiency metric for cars. Like cars, data centers have different designs, redundancy, and operational capabilities, and using the service efficiency metrics described in this disclosure, the efficiency of each of these elements may be measured by how many transactions may be executed for each watt consumed by the data center. Using this metric, the number of watts consumed per transaction may also be calculated.

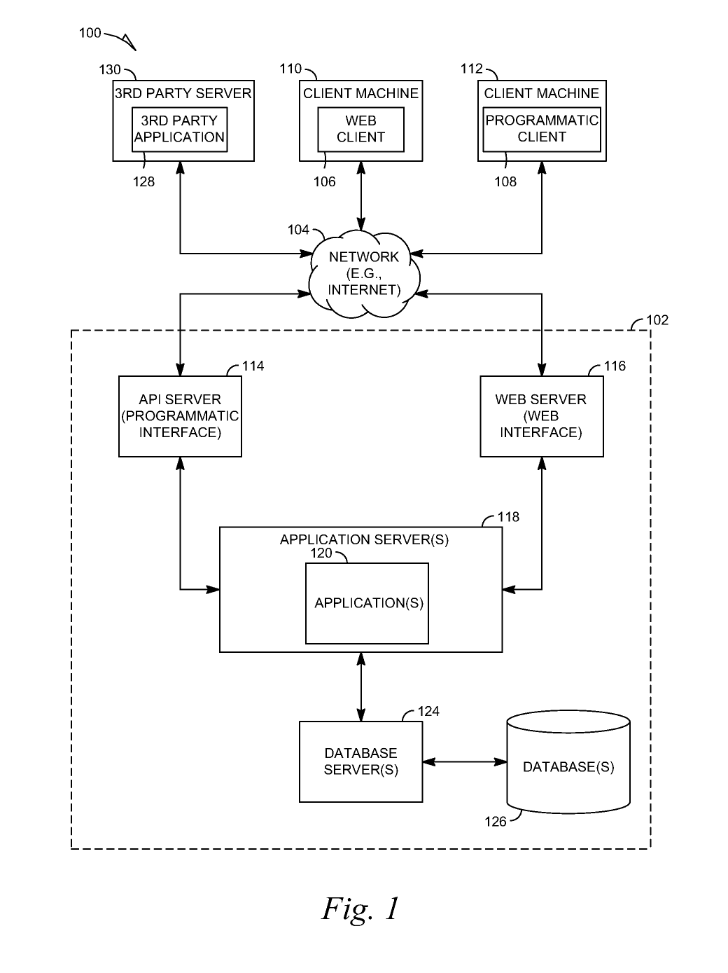

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

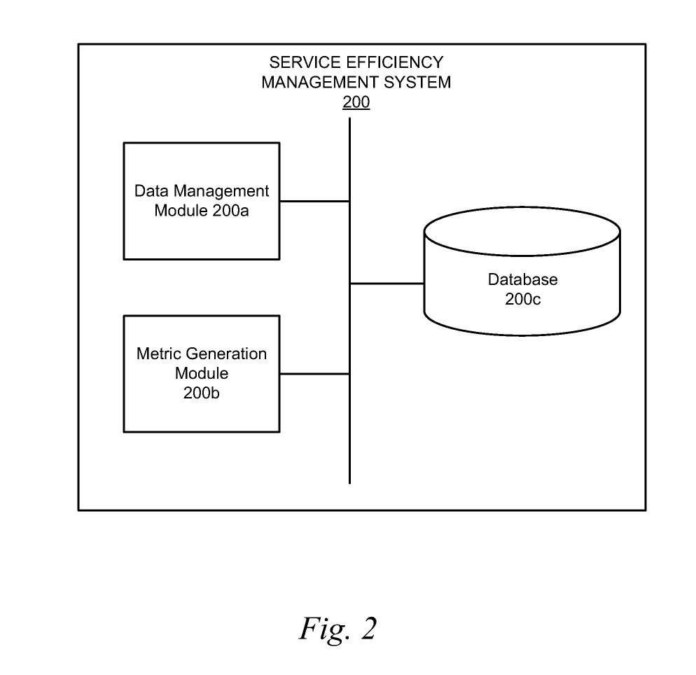

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a service efficiency management system 200 includes a data management module 200a, a metric generation module 200b, and a database 200c. The modules of the product display system 200 may be implemented on a single device such as a service efficiency management device (not shown), or on separate devices interconnected via a network. The aforementioned service efficiency management device may correspond to, for example, one of the client machines (e.g. 110, 112) or application server(s) 118 illustrated in FIG. 1.

The data management module 200a is configured to collect and manage various types of operations information pertaining to the operation of an online or offline business entity. An example of an online business is a website, a widget, or an application corresponding to a client application installed on a mobile device, such as a search engine website, an e-commerce website, a marketplace website, an app, a widget on a desktop or home screen, etc. Such online businesses may be hosted by one or more application servers (e.g., application server(s) 118 illustrated in FIG. 1) and/or web servers (e.g., web server 116 illustrated in FIG. 1). Such online businesses may be accessible through a network (e.g., the Internet) with use of a web browser application of a client device (e.g., client machine 110 or 112 in FIG. 1, which may correspond to a personal computer, a tablet, a smartphone, a mobile device, etc.), where the web browser application of the client device may access a specific Uniform Resource Locator (URL) reference link corresponding to the online business. Such aspects of a browser application that accesses web pages via a network are understood by those skilled in the art, and shall not be described further in the interests of brevity. While this disclosure refers throughout to an exemplary online business as an example of an entity that may utilize the service efficiency management system 200 of this disclosure, it should be understood that the various aspects and embodiments of this disclosure are applicable to the generation of service efficiency metrics for all entities and/or businesses, including online and offline businesses, and to online businesses accessed through technologies other than a web browser.

As described in more detail below, the operations information is data collected or calculated by the data management module 200a that indicates some aspect relating to the activities of the online business or resources being consumed by the operation of the online business, and may include: a number of transactions being executed at the online business in a given time period; the amount of power being consumed by the online business's data centers during a given time period; the amount of energy being consumed by the online business's data centers during a given time period; the number of users (unique or otherwise) of the online business during a given time period; a calculation result indicating the amount of carbon generated (or the amount of CO₂ generated or the amount of carbon emissions) due to the power consumption of the online business's data centers during a given time period; the cost incurred from operating the online business during a given time period; the revenue generated from operations of the online business during a given time period; and so forth. The given time periods described above (also referred to as “specific time periods” or “particular time periods” throughout) may be default time periods or user-specified time periods (e.g., specified based on user input to the system 200). Examples of time periods include 24 hours, 48 hours, 7 days, 1 month, etc.

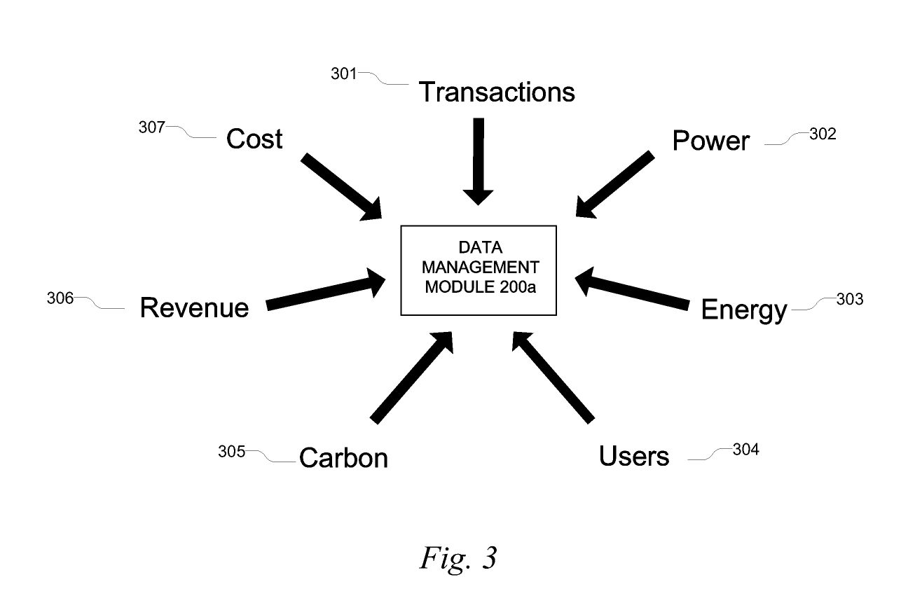

FIG. 3 illustrates some of the types of observed or calculated operations information that may be collected and managed by the data management module 200a. For example, the data management module 200a can receive: transaction information 301 indicating the number of transactions being executed at the online business in a give time period; power consumption information 302 indicating the amount of power being consumed by the online business's data centers during a given time period (where the amount of power consumed may be expressed in units of, for example, watts (W)); energy consumption information 303 indicating the amount of energy being consumed by the online business's data centers during a given time period (where the amount of energy consumed may be expressed in units of, for example, joules (J) or kilowatt-hours (kWh)); user count information 304 indicating the number of users (unique or otherwise) of the online business during a given time period; carbon generation information 305 indicating the amount of carbon generated (or the amount of CO₂ generated or the amount of carbon emissions) due to the power consumption of the online business's data centers during a given time period (where the amount of carbon generated may be expressed in units of, for example, pounds, grams, metric tonnes, carbon dioxide equivalent (CDE), equivalent carbon dioxide (CO₂e), etc.); revenue information 306 indicating the revenue (e.g., in US$) generated from operations of the online business during a given time period; and cost information 307 indicating the cost (e.g., in US$) incurred from operating the online business during a given time period.

As described above, the power consumption information 302 (indicating the amount of power being consumed by the online business's data centers during a given time period) may be expressed in units of, for example, watts (W), wherein the watt is the international standard unit of power. The power consumption information may be obtained from a businesses' utility power bill, which generally reflects the power consumption of various aspects of a data center, including IT load, chiller load, transformer losses, lighting administration areas, and so forth. In some cases, utility power bills from a utility power provider may use kilowatt-hours (kWh) as the basis of quantity and cost, wherein kWh is a unit for representing energy rather than power. Accordingly, if the system 200 receives an energy consumption value in kWh, the system may convert this into a power consumption value by multiplying it by one thousand and then multiplying the result by the number of hours it was billed against. That is, kWh=unit of energy equivalent to 1000 Watts of power expended for one hour of time, and Watts=kWh×1000×(if monthly then the number of hours as billed for the month). The choice of generating a service efficiency metric based on either the energy consumption information (e.g., in kWh) or based on the power consumption information (e.g., in watts) used over the course of time may be made by each business entity, depending upon their needs and how granular they would like make the metric to be.

Cost (e.g., cost information 307)=Total dollar value of the facility power bill for the billing cycle. The other key value that can be derived from the utility power bill is the monetary cost for the power over the course of the billing cycle to support the data center. This allows the Services value to be delineated in terms of the Operating Expenses to deliver the service.

The carbon generation information 305 may be expressed using various units understood by those skilled in the art, such as pounds, grams, metric tonnes, carbon dioxide equivalent (CDE), equivalent carbon dioxide (CO₂e), and so forth. The amount of carbon generated is indirectly dependent on the amount of power consumed by the online business's data centers, since the production of power associated with the workload of the data centers generally requires power plants that burn substances such as coal, thereby producing the associated carbon.

The data management module 200a may also collect a more specific subset of operations information, pertaining to the execution of specific types of services or transactions at an online business. For example, at the highest level, a marketplace website (such as eBay.com) may offer three primary services or transactions to their customers—Search, Sell, and Buy. Thus, specific types of services or transactions offered by a online business may include, for example, search transactions (such as search queries received from a user of the online business), seller listing transactions (such as when users of the online business post items for sale on the website of the online business), and purchase transactions (such as when users of the online business proceed to checkout or buy an item for sale on the website of the online business). This list of services or transactions is merely exemplary, and it should be understood that different businesses and online websites may, of course, be associated with other types of online and offline services or transactions (such as refunds, exchanges, queries, feedback, uploads, downloads, views, access events, updates, refreshes, etc.).

For each type of transaction executed at an online business, the data management module 200a may collect the various aforementioned types of operations information, as they pertain to the execution of that type of transaction at the online business, including: the number of that type of transaction being executed via the online business in a give time period; the amount of power being consumed by the online business's data centers in executing that type of transaction during a given time period; the amount of energy being consumed by the online business's data centers in executing that type of transaction during a given time period; the number of users (unique or otherwise) of the online business that are associated with that type of transaction during a given time period; the amount of carbon generated (or the amount of CO₂ generated or the amount of carbon emissions) due to the power consumption of the online business's data centers in executing that type of transaction during a given time period; the cost incurred in performing that type of transaction during a given time period, the revenue generated from that type of transaction during a given time period; and so forth.

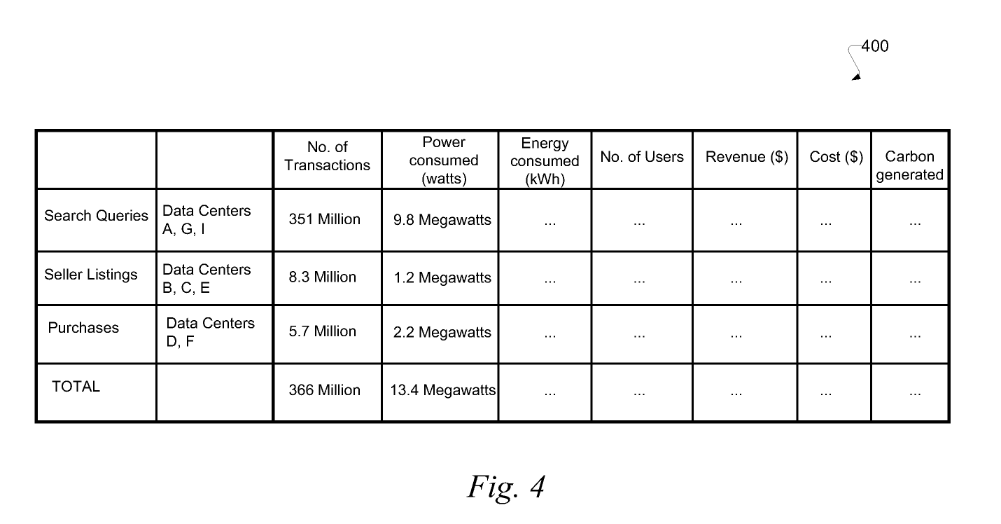

For example, FIG. 4 illustrates an example of a table 400 or similar data structure managed by the data management module 200a. As illustrated in FIG. 4, the table 400 lists multiple types of online services or transactions that are executed at a particular online business, including search queries, seller listings, and purchases. For each type of transaction, the table 400 lists the respective data centers (or particular service devices, computing devices, etc.) that are involved with the processing of those transactions, where this information may be detected automatically or specified via user input (e.g. the user input of an IT administrator of the online business).

Moreover, for each type of transaction, the table 400 lists various operations information including: the number of that type of transaction being executed via the corresponding data centers of the online business in a give time period; the amount of power being consumed by the corresponding data centers of the online business while executing that type of transaction during a given time period; the amount of energy being consumed by the corresponding data centers of the online business while executing that type of transaction during a given time period; the number of users (unique or otherwise) of the online business that are associated with that type of transaction during a given time period; the amount of carbon generated (or the amount of CO₂ generated or the amount of carbon emissions) due to the power consumption of the corresponding data centers of the online business while executing that type of transaction during a given time period; the operating cost incurred by the corresponding data centers of the online business while performing that type of transaction during a given time period; the online business's revenue generated from that type of transaction during a given time period; and so forth. The table 400 also lists the total amounts of each piece of operations information (e.g., number of transactions, power consumed, energy consumed, number of users, etc.) for all the types of transactions being executed at the online business.

The data management module 200a may collect the various operations information described above from various sources, including via user input (e.g., from IT administrators and engineers associated with the online business). In the case of various type of operations information (such as number of transactions, number of users, amount of power consumed, etc.), the data management module 200a may be able to automatically collect this information from web servers and data centers connected to the system 200, as understood by those skilled in the art. Further, since the information in table 400 identifies which data centers perform each type of service/transaction (e.g. data centers A, G and I handle search query transactions), the power utility bill for those particular data centers (e.g. data centers A, G and I) may be used by the system 200 to determine the power consumption, energy consumption, operating cost and carbon generation for the corresponding transactions (e.g., search query transactions). The power consumption information for a particular set of data centers may be referred to as a “data center power consumption value”. The data management module 200a may organize such information into a data structure, such as the data structure 400 illustrated in FIG. 4, where such as data structure may be stored at, for example the database 200c.

Based on the various types of operations information collected and managed by the data management module 200a, the metric generation module 200b is able to process the operations information in order to generate various types of service efficiency metrics. Such service efficiency metrics may provide a useful guide as to the efficiency of the online business, as described in more detail below.

### Transactions Per Watt

According to various exemplary embodiments, the data management module 200a is configured to collect transaction information and power consumption information of an online business, and the metric generation module 200b is configured to generate a service efficiency metric referred to as “transactions per watt”.

The transaction information is a piece of operations information that is collected by the data management module 200a and indicates a total number of transactions being executed at the online business, including transactions of various types such as search queries, seller listings/postings, and purchases. For example, with reference to the operations information of table 400, the data management module 200a collects transaction information indicating that 366 million transactions have been executed at the online business in a given time period (e.g., one day).

The power consumption information collected by the data management module 200a indicates an amount of power consumed by data centers associated with the online business while executing the aforementioned 366 million transactions (including transactions of various types such as search queries, seller listings/postings, and purchases) in the given time period. For example, with reference to the operations information of table 400, the data management module 200a collects power consumption information indicating that 13.4 megawatts have been consumed by data centers associated with the online business while executing the aforementioned 366 million transactions in the given time period.

The metric generation module 200b is configured to generate a service efficiency metric based on the transaction information and power consumption information. In particular, the metric generation module 200b is configured to generate a service efficiency metric indicating a number of transactions executed at the online business during a specific time period, per unit of power consumed by operating the online business during the specific time period. For example, with reference to the operations information of table 400, the metric generation module 200b may divide the transaction information (366 Million transactions) by the power consumption information (e.g., 13.4 Megawatts) to generate a service efficiency metric of 27.29 transactions per watt. This indicates that, during the given time period, 27.29 transactions were performed for each watt of power consumed by the data centers.

While the service efficiency metric of transactions per watt described above was generated based on the total number of transactions of different types executed at the online business, the metric generation module 200b may calculate a service efficiency metric of transactions per watt for each type of transaction executed at the online business.

For example, the data management module 200a is configured to collect transaction information indicating a total number of a particular type of transaction (e.g., search queries) being executed at the online business. For example, with reference to the operations information of table 400, the data management module 200a collects transaction information indicating that 351 million search query transactions have been executed at the online business in a given time period (e.g., one day). The data management module 200a is also configured to collect power consumption information indicating an amount of power consumed by data centers associated with the online business while executing the aforementioned particular type of transaction (e.g., search queries) in the given time period. For example, with reference to the operations information of table 400, the data management module 200a collects power consumption information indicating that 9.8 megawatts have been consumed by data centers associated with the online business while executing the particular type of transaction (e.g., the aforementioned 351 million search queries) in the given time period.

Thereafter, the metric generation module 200b is configured to generate a service efficiency metric for each particular type of transaction (e.g., search queries), based on the transaction information and power consumption information for the particular type of transaction. That is, the metric generation module 200b is configured to generate a service efficiency metric indicating how many of the particular transactions have been executed at the online business during a specific time period, per unit of power consumed by the online business's data centers in executing those particular transactions during the specific time period. For example, with reference to the exemplary operations information of table 400, the metric generation module 200b may divide the transaction information (i.e., 351 million searches) by the power consumption information (i.e., 9.8 Megawatts) to generate a service efficiency metric of 35.61 transactions per watt for search query transactions (which may also be referred to as 35.61 searches per watt). This indicates that, during the given time period, 35.61 search query transactions were performed, for each watt of power consumed by the data centers in executing the search query transactions during the given time period.

In a similar manner, the metric generation module 200b may generate a service efficiency metric of 6.77 transactions per watt for seller listing transactions (which may also be referred to as 6.77 listings per watt). This indicates that, during the given time period, 6.77 seller listing transactions were performed, for each watt of power consumed by the data centers in executing the seller listing transactions. And in a similar manner, the metric generation module 200b may generate a service efficiency metric of 2.49 transactions per watt for purchase/checkout transactions (which may also be referred to as 2.49 checkouts per watt). This indicates that, during the given time period, 2.49 purchase transactions were performed, for each watt of power consumed by the data centers in executing the purchase transactions.

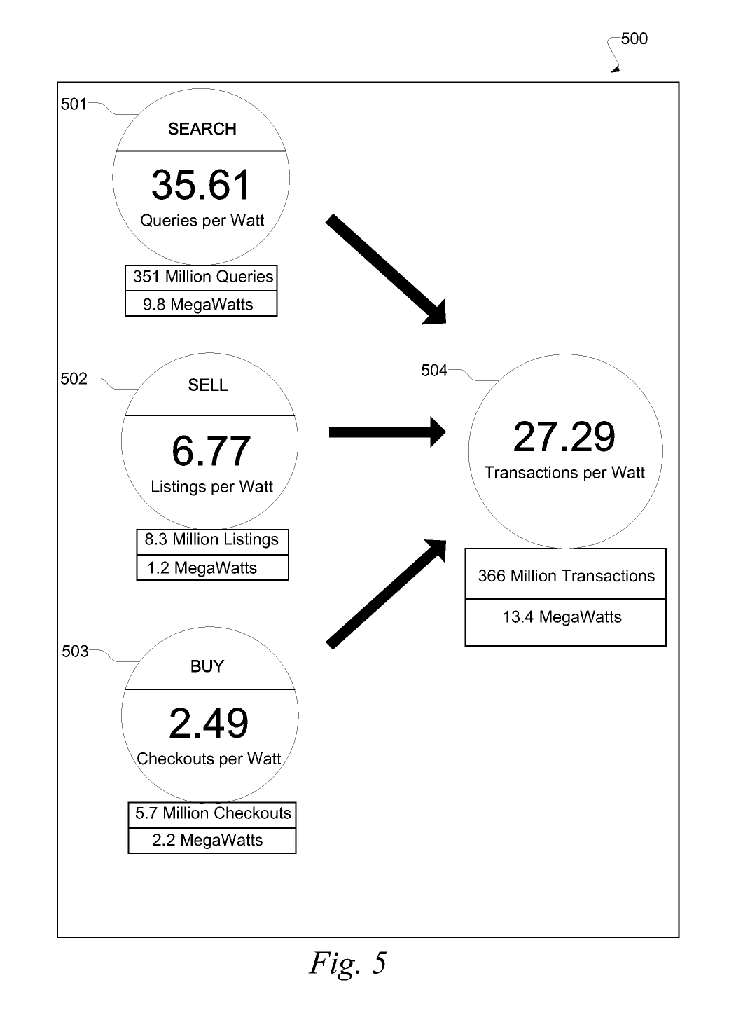

The metric generation module 200b may also display one or more generated service efficiency metrics on a display module connected to the service efficiency management system 200. For example, FIG. 5 illustrates an example user interface screen 500 displayed on a display module (e.g., display screen or monitor) connected to the service efficiency management system 200. User interface screen 500 displays various service efficiency metrics of “transactions per watt” generated by the metric generation module 200b, based on the operations information in table 400.

In particular, the user interface 500 of FIG. 5 illustrates the user consumption of each type of service or transaction (including search queries, seller listings and purchase checkouts), and the corresponding wattage to deliver it over a 24-hour period. For example, area 501 of the user interface 500 illustrates that on a given day there were 351 million search queries performed by active users, and these searches required 9.8 Megawatts of power to be completed. Thus, the metric generation module 200b determines that on that day there was an average of 35.61 searches per watt. Similarly, area 502 of the user interface 500 illustrates that on a given day there were 8.3 million new listings (or new items for sale on marketplace website), and the posting of these listings required 1.2 Megawatts of power. Thus, the metric generation module 200b determines that there was an average of 6.77 listings per watt. Similarly, area 503 of the user interface 500 illustrates that on a given day there were 5.7 million checkouts or purchases, and the execution of these purchases required 2.2 Megawatts of power. Thus, the metric generation module 200b determines that there were 2.49 checkouts per watt in that 24-hour period.

To generate the total “transactions per watt”, the metric generation module 200b may effectively combine each type of service/transaction (including search queries, seller listings, and purchases), and divide it by the total watts consumed. As illustrated in area 504 of the user interface 500, in that 24-hour period, the online business delivered 366 million transactions and consumed 13.4 Megawatts of power, effectively delivering 27.29 transactions per watt.

Thus, according to various exemplary embodiments, a service efficiency management system generates a service efficiency metric of transactions per watt. This metric tracks how efficiently online and offline businesses (such as marketplace websites) deliver core services to customers. In particular, the system 200 produces the “transactions per watt” metric based on how customers consume services of the business (actual user transactions) and the total amount of power to deliver those services (watts). All changes in the infrastructure of the business (e.g., data center consolidation, technology refresh, code optimization, etc.) will either increase or decrease “transactions per watt”.

For example, a marketplace website (such as eBay.com) may offer three primary services or transactions to their customers—Search, Buy, and Sell. Each of these services requires IT equipment (servers, storage, networking, etc.) and physical data center infrastructure. This infrastructure consumes wattage to complete each transaction from a user request. Thus, the system 200 generates the service efficiency metric “transactions per watt” that provides a methodology that simplifies the measurement of this user consumption. The higher the transactions in the “transactions per watt” service efficiency metric, the more efficiently the services are being delivered. In essence, the “transactions per watt” efficiency metric of a company's infrastructure may be treated as analogous to the “miles per gallon” efficiency metric for cars. Like cars, data centers have different designs, redundancy, and operational capabilities, and using the service efficiency metric of this disclosure, the efficiency of each of these elements may be measured by how many transactions may be performed (analogous to how many “miles” may be driven) for every watt of power (analogous to every “gallon of fuel”) they consume.

Accordingly, during operations, the service efficiency metric generated by the system 200 may be used to help drive down costs and increase utilization of the services provided by an online business. For example, a business may set a target to baseline a “transactions per watt”—and corresponding “$ per watt” (described below)—to expose how efficiently the business is utilizing its infrastructure to deliver services for customers, and ultimately what that cost per watt is to deliver it. From there, the business may set targets to increase the transactions per watt, decrease the cost per watt, and so forth.

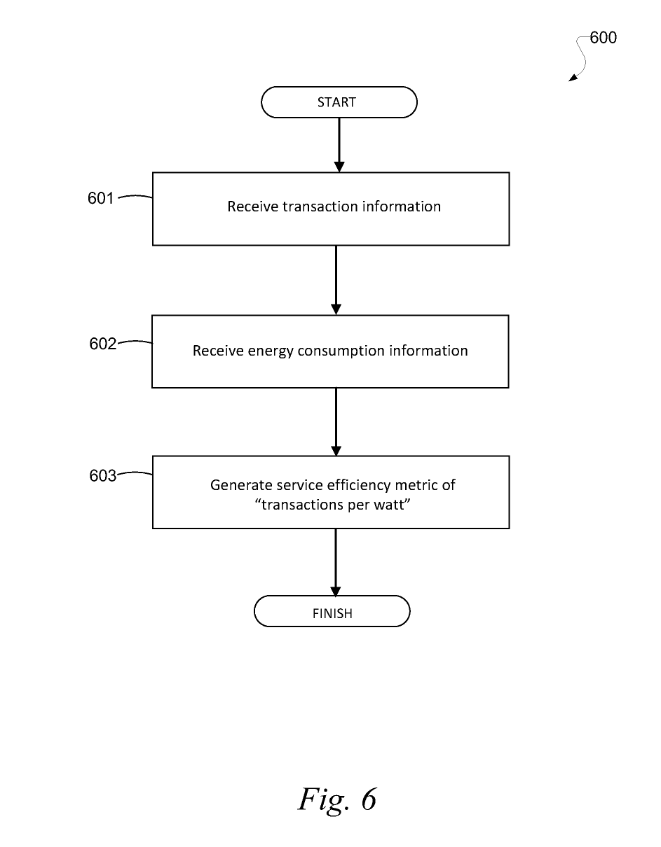

FIG. 6 is a flowchart illustrating an example method 600, according to various embodiments. The method 600 may be performed at least in part by, for example, the service efficiency management system 200 illustrated in FIG. 2 (or a service efficiency management device having similar modules, such as client machines 110 and 112 or application server 112 illustrated in FIG. 1). In 601, the system receives transaction information, and in 602 the system receives power consumption information. In 603, the system generates a service efficiency metric of transactions per watt, based on the transaction information and power consumption information, the service efficiency metric of transactions per watt indicating a number of transactions executed via the online business during a specific time period, per unit of power consumed in executing the transactions during the specific time period.

According to various exemplary embodiments described below, the metric generation module is configured to generate other service efficiency metrics based on the other types of operations information. That is, the data management module 200a may receive at least two types of operations information, such as two of the various types of operations information illustrated in FIGS. 3 and 4, including: number of transactions, power consumption, energy consumption, number of users, cost, revenue, and carbon generated. Based on these two types of operations information, the metric generation module 200b may generate various types of service efficiency metrics.

More specifically, using the example of the operations information in table 400 of FIG. 4, for a given type of service/transaction (e.g., search queries, seller listing, purchases, all of the above), the metric generation module 200b may obtain a first operations value for the specific type of transaction (e.g. number of transactions, power consumption in executing the transactions, energy consumption in executing the transactions, number of users performing the transactions, revenue generated as a result of the transactions, cost of performing the transactions, and carbon generated in performing the transactions), and a second operations value for the specific type of transaction (e.g. number of transactions, power consumption in executing the transactions, energy consumption in executing the transactions, number of users performing the transactions, revenue generated as a result of the transactions, cost of performing the transactions, and carbon generated in performing the transactions). Thereafter, the metric generation module 200b may divide the first operations value by the second operations value, in order to generate service efficiency metric.

Examples of service efficiency metrics include performance-based service efficiency metrics that track and reflect performance, such as: Transactions per Watt (TpW), Transactions per User (TpU), and Watts per User (WpU). Other examples of service efficiency metrics include cost-based service efficiency metrics that track and reflect cost, such as Cost per Watt ($pW), Cost per User ($pU), Cost per Transaction ($pT). Other examples of service efficiency metrics include revenue-based service efficiency metrics that track and reflect revenue, such as Revenue per Watt (RpW), Revenue per Transaction (RpT), and Revenue per User (RpU). Other examples of service efficiency metrics include environmental-based service efficiency metrics that track and reflect environmental impact and/or carbon generation, such as Carbon per Watt (CpW), Carbon per Transaction (CpT), Carbon per User (CpU).

Other examples of service efficiency metrics include Transactions per Dollar Cost (Tp$), Transactions per Dollar Revenue (TpR), Transactions per Unit of Carbon generated (TpC), Transactions per Unit of Energy (TpE), Watts consumed per Transaction (WpT), Watts consumed per Dollar of Cost (Wp$), Watts consumed per Dollar of Revenue (TpR), Watts consumed per Unit of Carbon generated (TpC), Watts per Unit of Energy (WpE), Users per Transaction (UpT), Users per Watt consumed (UpW), Users per Dollar of Cost (Up$), Users per Dollar of Revenue (UpR), Users per Unit of Carbon generated (UpC), Users per Unit of Energy (UpE), Cost per Dollar of Revenue (CpR), Cost per Unit of Carbon generated ($pC), Cost per Unit of Energy ($pE), Revenue per Unit of Cost (Rp$), Revenue per Unit of Carbon generated (RpC), Revenue per Unit of Energy (RpE), Carbon generated per Dollar of Cost (Cp$), Carbon generated per Dollar of Revenue (CpR), Carbon per Unit of Energy (CpE), Energy per Transaction (EpT), Energy per Watt (EpW), Energy per user (EpU), Energy per Dollar of Cost (Ep$), Energy per Dollar of Revenue (EpR), Energy per Unit of Carbon generated (EpC).

As described above, each of the aforementioned metrics may be calculated based only on specific types of service/transactions being executed at an online business, or based on all the transactions being executed at the online business.

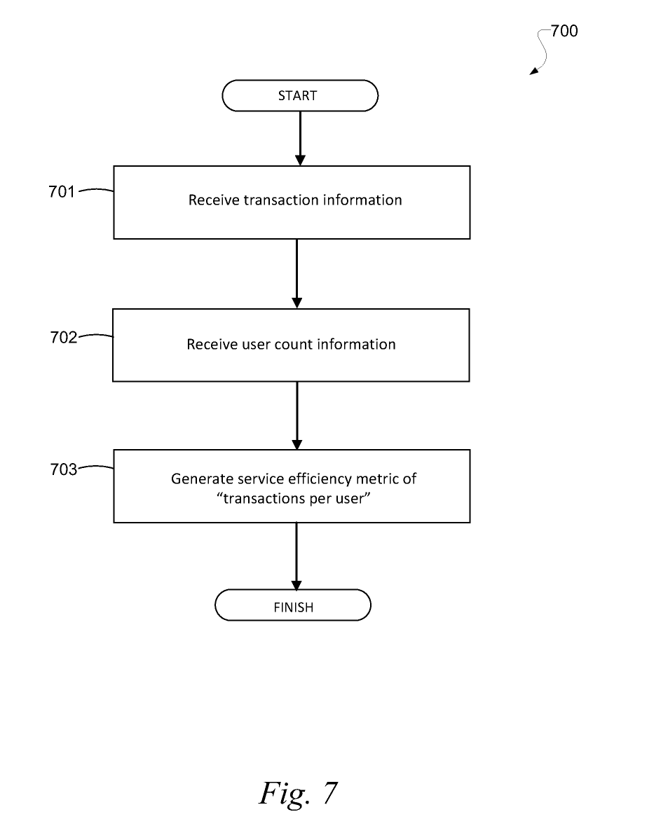

FIG. 7 is a flowchart illustrating an example method 700, according to various embodiments. The method 700 may be performed at least in part by, for example, the service efficiency management system 200 illustrated in FIG. 2 (or a service efficiency management device having similar modules, such as client machines 110 and 112 or application server 112 illustrated in FIG. 1). In 701, the system receives transaction information, and in 702 the system receives user count information. In 703, the system generates a service efficiency metric of transactions per user, based on the transaction information and the user count information, the service efficiency metric of transactions per user indicating a number of transactions executed via the online business during a specific time period, per user of the online business during the specific time period.

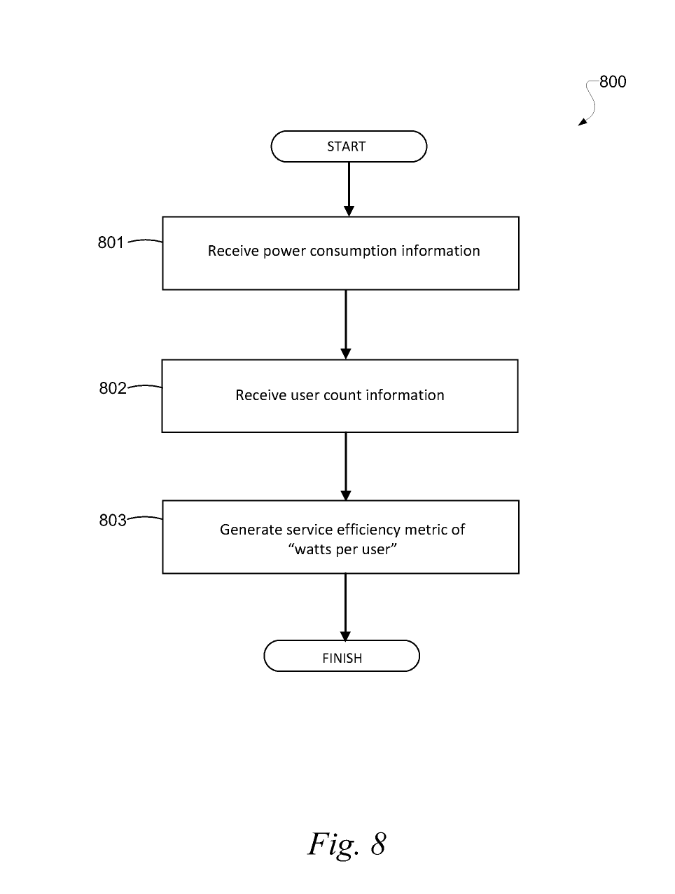

FIG. 8 is a flowchart illustrating an example method 800, according to various embodiments. The method 800 may be performed at least in part by, for example, the service efficiency management system 200 illustrated in FIG. 2 (or a service efficiency management device having similar modules, such as client machines 110 and 112 or application server 112 illustrated in FIG. 1). In 801, the system receives power consumption information, and in 802 the system receives user count information. In 803, the system generates a service efficiency metric of watts per user, based on the power consumption information and user count information, the service efficiency metric of watts per user indicating an amount of power consumed by operations of the online business during a specific time period, per user of the online business during the specific time period.

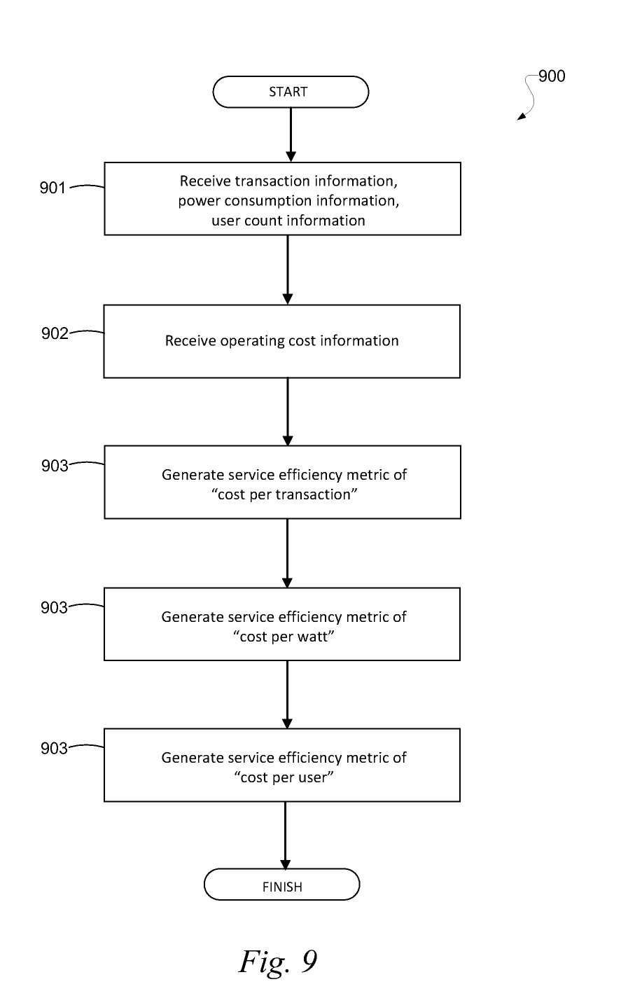

FIG. 9 is a flowchart illustrating an example method 900, according to various embodiments. The method 900 may be performed at least in part by, for example, the service efficiency management system 200 illustrated in FIG. 2 (or a service efficiency management device having similar modules, such as client machines 110 and 112 or application server 112 illustrated in FIG. 1). In 901, the system receives transaction information, power consumption information, and user count information. In 902, the system receives operating cost information. In 903, the system generates a service efficiency metric of cost per transaction, based on the operating cost information and transaction information, the service efficiency metric of cost per transaction indicating a cost in operating the online business during a specific time period, per transaction executed at the online business during the specific time period. In 904, the system generates a service efficiency metric of cost per watt, based on the operating cost information and power consumption information, the service efficiency metric of cost per watt indicating a cost in operating the online business during a specific time period, per unit of power consumed in operating the online business during the specific time period. In 905, the system generates a service efficiency metric of cost per user, based on the operating cost information and user count information, the service efficiency metric of cost per user indicating a cost in operating the online business during a specific time period, per user of the online business during the specific time period.

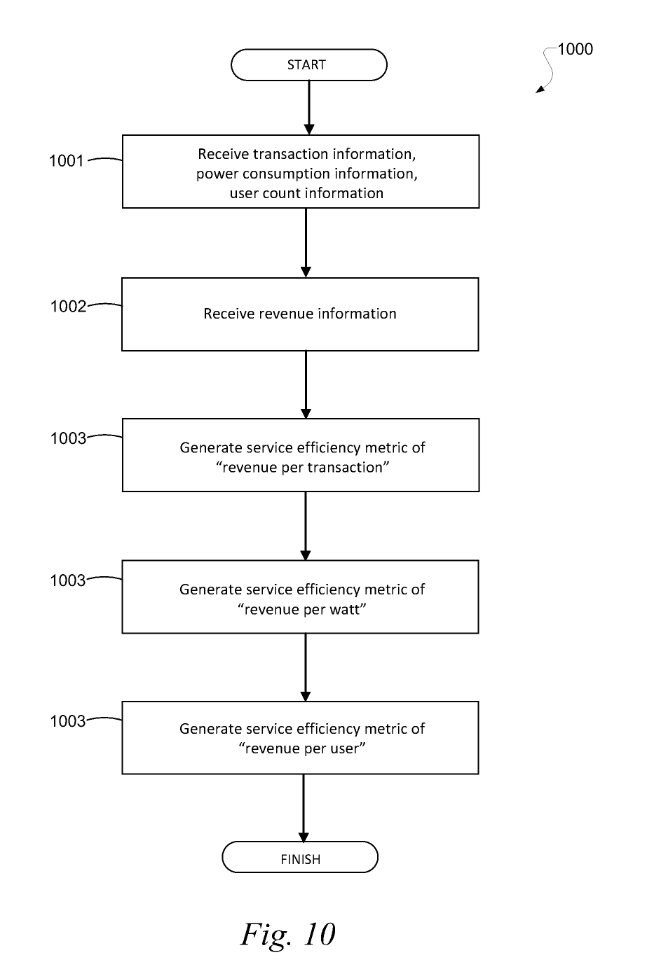

FIG. 10 is a flowchart illustrating an example method 1000, according to various embodiments. The method 1000 may be performed at least in part by, for example, the service efficiency management system 200 illustrated in FIG. 2 (or a service efficiency management device having similar modules, such as client machines 110 and 112 or application server 112 illustrated in FIG. 1). In 1001, the system receives transaction information, power consumption information, and user count information. In 1002, the system receives revenue information. In 1003, the system generates a service efficiency metric of revenue per transaction, based on the revenue information and transaction information, the service efficiency metric of revenue per transaction indicating revenue in operating the online business during a specific time period, per transaction executed at the online business during the specific time period. In 1004, the system generates a service efficiency metric of revenue per watt, based on the revenue information and power consumption information, the service efficiency metric of revenue per watt indicating revenue in operating the online business during a specific time period, per unit of power consumed in operating the online business during the specific time period. In 1005, the system generates a service efficiency metric of revenue per user, based on the revenue information and user count information, the service efficiency metric of revenue per user indicating revenue in operating the online business during a specific time period, per user of the online business during the specific time period.

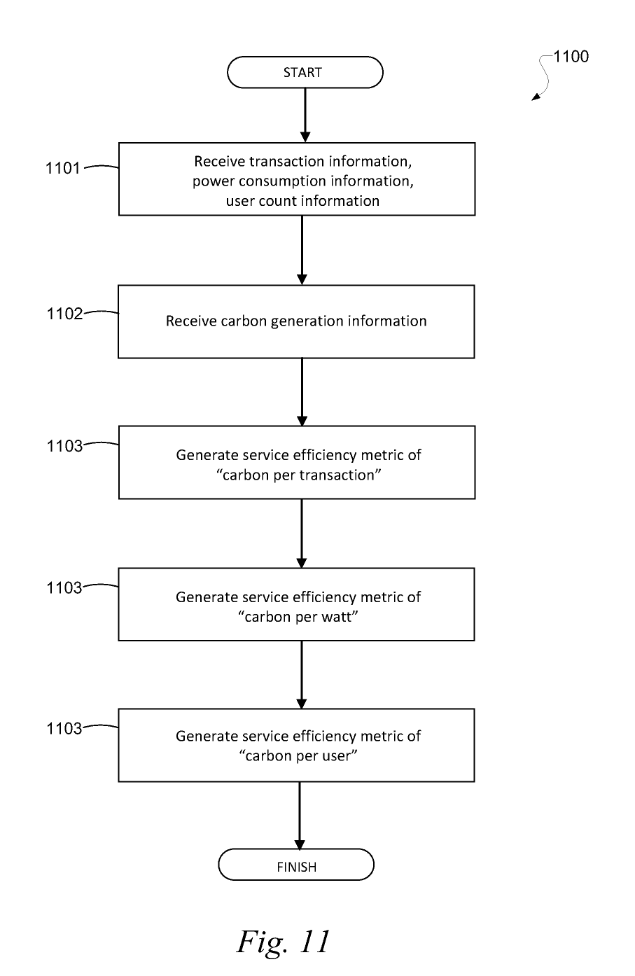

FIG. 11 is a flowchart illustrating an example method 1100, according to various embodiments. The method 1100 may be performed at least in part by, for example, the service efficiency management system 200 illustrated in FIG. 2 (or a service efficiency management device having similar modules, such as client machines 110 and 112 or application server 112 illustrated in FIG. 1). In 1101, the system receives transaction information, power consumption information, and user count information. In 1102, the system receives carbon generation information. In 1103, the system generates a service efficiency metric of carbon per transaction, based on the carbon generation information and transaction information, the service efficiency metric of carbon per transaction indicating an amount of carbon generated due to power consumption of the online business's data centers during a specific time period, per transaction executed at the online business during the specific time period. In 1104, the system generates a service efficiency metric of carbon per watt, based on the carbon generation information and power consumption information, the service efficiency metric of carbon per watt indicating an amount of carbon generated due to power consumption of the online business's data centers during a specific time period, per unit of power consumed in operating the online business during the specific time period. In 1105, the system generates a service efficiency metric of carbon per user, based on the carbon generation information and user count information, the service efficiency metric of carbon per user indicating an amount of carbon generated due to power consumption of the online business's data centers during a specific time period, per user of the online business during the specific time period.

According to various exemplary embodiments, the metric generation module 200b is also configured to analyze one of the service efficiency metrics described in this disclosure (e.g., transactions per watt), in order to output a recommendation for improving the service efficiency metric. For example, if the metric generation module detects that the given service efficiency metric drops below a predetermined threshold (which may be inputted by a user of the system 200), the metric generation module 200b may output a recommendation to improve a value of the service efficiency metric. For example, the recommendation may be: consolidating plural data center operations associated with the online business; replacing specific equipment associated with the online business; or optimizing a piece of software code associated with the online business.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

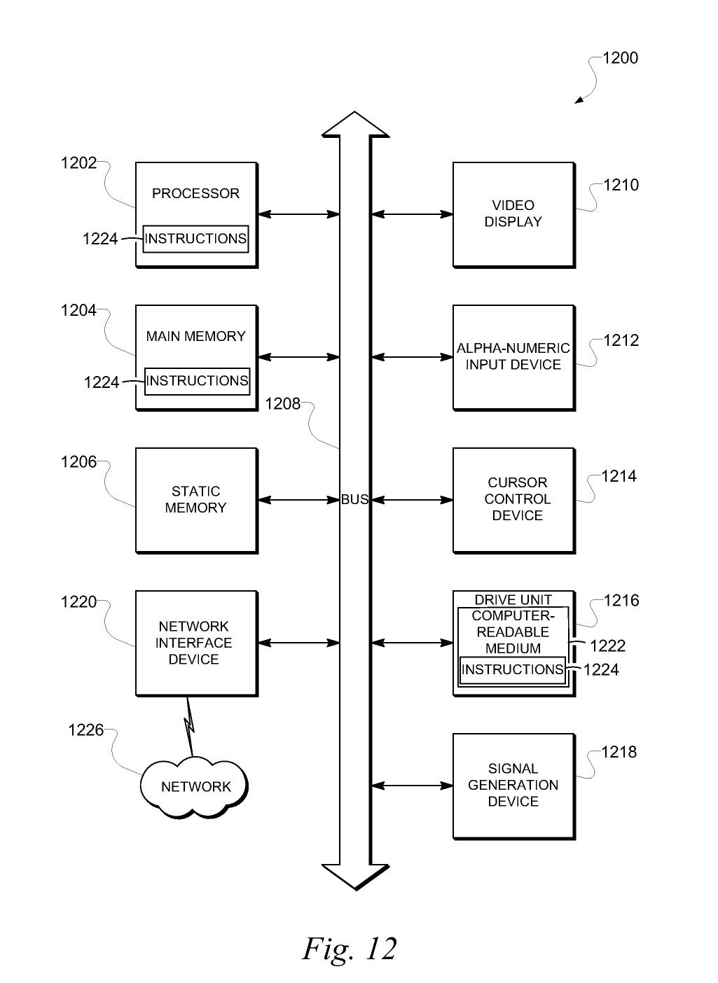

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
receiving transaction information and power consumption information of an online business; and
generating, using one or more processors, a service efficiency metric based on the transaction information and the power consumption information, the service efficiency metric indicating a number of transactions executed via the online business during a specific time period per unit of power consumed in executing the transactions during the specific time period.

2. The method of claim 1, wherein the transactions include search queries, and the power consumed includes a data center power consumption value observed at one or more data centers that execute the search queries.

3. The method of claim 1, wherein the transactions include posting of seller listings, and the power consumed includes a data center power consumption value observed at one or more data centers that execute the posting of the seller listings.

4. The method of claim 1, wherein the transactions include purchases, and the power consumed includes a data center power consumption value observed at one or more data centers that execute the purchases.

5. The method of claim 1, further comprising:
generating a second service efficiency metric based on the transaction information and a user count, the second service efficiency metric indicating a number of transactions executed via the online business during a particular time period per user during the particular time period.

6. The method of claim 1, further comprising:
generating a third service efficiency metric based on the power consumption information and a user count, the third service efficiency metric indicating an amount of power consumed by operations of the online business during a particular time period per user during the particular time period.

7. The method of claim 1, further comprising:
receiving operating cost information and user count information; and
generating at least one of:
a cost-per-transaction service efficiency metric based on the operating cost information and the transaction information;
a cost-per-watt service efficiency metric based on the operating cost information and the power consumption information; and
a cost-per-user service efficiency metric based on the operating cost information and the user count information.

8. The method of claim 1, further comprising:
receiving revenue information and user count information; and
generating at least one of:
a revenue-per-transaction service efficiency metric based on the revenue information and the transaction information;
a revenue-per-watt service efficiency metric based on the revenue information and the power consumption information; and
a revenue-per-user service efficiency metric based on the revenue information and the user count information.

9. The method of claim 1, further comprising:
receiving carbon generation information and user count information; and
generating at least one of:
a carbon-per-transaction service efficiency metric based on the carbon generation information and the transaction information;
a carbon-per-watt service efficiency metric based on the carbon generation information and the power consumption information; and
a carbon-per-user service efficiency metric based on the carbon generation information and the user count information.

10. The method of claim 1, further comprising:
generating a recommendation to improve a value of the service efficiency metric based on the service efficiency metric.

11. A service efficiency management system comprising:
a data management module operable to receive transaction information and power consumption information of an online business; and
a metric generation module operable to generate, using one or more processors, a service efficiency metric based on the transaction information and the power consumption information, the service efficiency metric indicating a number of transactions executed at the online business during a specific time period per unit of power consumed by operating the online business during the specific time period.

12. The method of claim 1, wherein the transactions include search queries, and the power consumed includes a data center power consumption value observed at one or more data centers that execute the search queries.

13. The method of claim 1, wherein the transactions include posting of seller listings, and the power consumed includes a data center power consumption value observed at one or more data centers that execute the posting of the seller listings.

14. The method of claim 1, wherein the transactions include purchases, and the power consumed includes a data center power consumption value observed at one or more data centers that execute the purchases.

15. The method of claim 1, wherein the metric generation module is further configured to:
generate a second service efficiency metric based on the transaction information and a user count, the second service efficiency metric indicating a number of transactions executed via the online business during a particular time period per user during the particular time period.

16. The method of claim 1, wherein the metric generation module is further configured to:
generate a third service efficiency metric based on the power consumption information and a user count, the third service efficiency metric indicating an amount of power consumed by operations of the online business during a particular time period per user during the particular time period.

17. The method of claim 1, wherein the metric generation module is further configured to:
receive operating cost information and user count information; and
generate at least one of:
a cost-per-transaction service efficiency metric based on the operating cost information and the transaction information;
a cost-per-watt service efficiency metric based on the operating cost information and the power consumption information; and
a cost-per-user service efficiency metric based on the operating cost information and the user count information.

18. The method of claim 1, wherein the metric generation module is further configured to:
receive revenue information and user count information; and
generate at least one of:
a revenue-per-transaction service efficiency metric based on the revenue information and the transaction information;
a revenue-per-watt service efficiency metric based on the revenue information and the power consumption information; and
a revenue-per-user service efficiency metric based on the revenue information and the user count information.

19. The method of claim 1, wherein the metric generation module is further configured to:
receive carbon generation information and user count information; and
generate at least one of:
a carbon-per-transaction service efficiency metric based on the carbon generation information and the transaction information;
a carbon-per-watt service efficiency metric based on the carbon generation information and the power consumption information; and
a carbon-per-user service efficiency metric based on the carbon generation information and the user count information.

20. A non-transitory machine-readable storage medium having embodied thereon instructions executable by one or more machines to perform operations comprising:
receiving transaction information and power consumption information of the online business; and
generating, using one or more processors, a service efficiency metric based on the transaction information and the power consumption information, the service efficiency metric indicating a number of transactions executed via the online business during a specific time period per unit of power consumed in executing the transactions during the specific time period.
